(19) United States
(12) Patent Application Publication
(10) Pub. No.: US 2016/0111015 A1
(43) Pub. Date: Apr. 21, 2016

(54) System and method for emotional relief

(71) Applicant: Donald J. Zandier, JR., Pittsburgh, PA (US)

(72) Inventor: Donald J. Zandier, JR., Pittsburgh, PA (US)

(21) Appl. No.: 14/882,597

(22) Filed: Oct. 14, 2015

Related U.S. Application Data
(60) Provisional application No. 62/064,077, filed on Oct. 15, 2014.

(51) Int. Cl. G09B 19/00

(52) U.S. Cl. CPC G09B 19/00

(57) ABSTRACT

A computer program product and method for mental health treatment. A sequence of operations are performed on a patient, including guiding a patient to an area of the mind needing treatment. The area of the mind needing treatment is then softened to facilitate acceptance of the disorder. One or more emotional traumas (ET) are isolated along with one or more emotional malnourishments (EM). The ETs and EMs are then resolved, thereby forming resolutions. The resolutions are protected, i.e. the emotional signal is prevented from reactivating. Next, positive reinforcement history of maladaptive coping behaviors (PRHx) is treated and protected, wherein, as a practical application of the operations, maladaptive emotions of said patient are neutralized.

### CROSS REFERENCE TO RELATED APPLICATIONS

Benefit is hereby claimed to provisional application Ser. No. 62/064,077, filed Oct. 15, 2014, the contents of which are incorporated by reference.

### BACKGROUND

1. Field of the Invention

The instant invention relates to mental health treatment. In particular, the invention comprehends a program for neutralizing maladaptive emotions.

2. Description of the Related Art

The effectiveness of mental health treatments vary from individual to individual, largely because specific experiences may be the original cause of a problem. Comparable programs focus treatment on how the subject currently feels and relieves only that “surface” feeling. Other programs treat only one problem area at a time, and because they often do not get to all of the primary causes, a degree of the problem usually persists or re-emerges. Similar approaches are also much less effective at altering maladaptive behaviors such as obsessions and compulsions. They do not address the long history that a bad habit creates and instead focus on the current behavior alone. These approaches bring some relief but not resolution.

However, it is the collective history of our personal experiences that form our emotional program which, in turn, fuels our ongoing emotional problems. By focusing treatment on the identification and isolation of an entire history of specific negative experiences, many negative emotions and behaviors are resolved at once. Moreover, because these specific experiences are the original cause of our problems, the problems never re-emerge.

### SUMMARY

Three primary experiences have been identified that create and maintain many emotional and behavioral problems: (1) emotional trauma (ET); (2) emotional malnourishment (EM); and, (3) the positive reinforcement history of maladaptive coping behaviors (PRHx). The instant program pulls up the entire history of these experiences from the subconscious mind to the preconscious vestibule of the mind where this active information can then be neutralized. The understanding of collective experiences make the suggested methodology possible, and understanding and implementing this knowledge is a critical “human step” in understanding the instant method. With just one application of this protocol, the subject feels dramatic emotional relief and greater control over maladaptive ways of coping.

Accordingly the invention comprehends a computer program product and method for mental health treatment, comprising the steps of performing a sequence of operations on a patient, including guiding a patient to an area of the mind needing treatment. The area of the mind needing treatment is then softened to facilitate acceptance of the disorder. One or more emotional traumas (ET) are isolated along with one or more emotional malnourishments (EM). The ETs and EMs are then resolved, thereby forming resolutions. The resolutions are protected, i.e. the emotional signal is prevented from reactivating. Next, positive reinforcement history of maladaptive coping behaviors (PRHx) is treated and protected, wherein, as a practical application of the operations, maladaptive emotions of said patient are neutralized.

The method further comprises the steps of improving balance of an external emotional immune system. Additionally, the steps are repeated as it relates, next, to an internal emotional immune system. For the step of guiding the patient, the mind is attuned and three interpersonal modes are attuned. For the step of softening the area, the external emotional immune system is attuned. For the step of softening the area, acupressure is applied to the external emotional immune system. Lastly, for the step of treating and protecting the PRHx, the PRHx is attuned according to a reference chart.

### BRIEF DESCRIPTION OF THE DRAWINGS

FIGS. 1 and 2 show a flow chart of the overall process.

FIG. 3 shows the reference chart used in conjunction with part of the process and as referenced by FIG. 1.

The flow charts, diagrammatic illustrations and/or sections thereof represent the method with computer logic or program flow that can be executed by a specialized device or a computer and/or implemented on computer readable media or the like (residing on a drive or device after download) tangibly embodying the program of instructions. The executions can be performed orally or from a computer or specialized device as part of a global communications network such as the Internet. For example, a computer typically has a web browser installed within the CPU for allowing the viewing of information retrieved via a network on the display device. A network may also be construed as a local, ethernet connection or a global digital/broadband or wireless network or cloud computing network or the like. The specialized device may include any device having circuitry or be a hand-held device, including but not limited to a tablet, smart phone, cellular phone or personal digital assistant (PDA) including but not limited to a mobile smartphone running a mobile software application (App). Accordingly, multiple modes of implementation are possible and “system” or “computer program product” or “non-transitory computer readable medium” covers these multiple modes.

### DETAILED DESCRIPTION OF THE PREFERRED EMBODIMENT

The instant system and methodology, or program, is a sequence of operations performed on the human mind, which process the data responsible for emotional and behavioral anomalies. Each operation is constructed of digital, visual, auditory and tactile stimuli, which navigates the user's mind to the relevant database and quarantines that data. The coded messages are constructed in the following order: the emotional mind; the three (3) interpersonal modes of operation; the exterior emotional immune system; the interior emotional immune system; the trauma files; the emotional malnourishment files; the positive reinforcement of maladaptive behavior files.

The program assumes that the mind works much like a computer, and therefore, the mind files away every life experience. The instant program accesses the subject's specific emotional history responsible for the development of their emotional and behavioral problem. The program's “access” can be done manually by direct, human intervention or with the aid of a computer or specialized device as above with video or web-cam capabilities through which the human intervention is fed, thus a critical human step is required by one possessing psychotherapy training.

The specific five life experiences are identified as follows: other inflicted emotional trauma; self-inflicted emotional trauma; other inflicted emotional malnourishment; self-inflicted emotional malnourishment and the positive reinforcement history of maladaptive coping behaviors. The instant program pulls up the entire history of these events by assuming the manner by which they are filed.

To improve access to the emotional program, the program lowers the personality's resistance to change. Personality is conceptualized as the emotional body's immune system which has an exterior mode (how we relate to others) and an interior mode (how we relate to ourselves). This program accesses and treats every interpersonal mode of operation (the parent, child and adult). The program also applies a treatment protection preventing the treatment from wearing off.

The program proposes that the mind is a field of energy and information that is located along energy pathways in the body called meridians. This information can be accessed through conscious thought much like an individual pulls up information from a computer program. The program isolates the specific history of emotional experiences stored in the mind that communicate emotional and behavioral problems. This is accomplished by first assuming that we all have both a physical body and an emotional body and that the emotional body functions much like the physical body; therefore, the emotional body can be wounded and malnourished as the physical body is. However, these events are stored in our computer-like mind.

This same program may be utilized to treat physical conditions if the conditions are psychogenic in nature. It may also be possible to eliminate some steps, rearrange the order or change stimuli slightly and get the same results; however, some means of clustering relevant information is necessary.

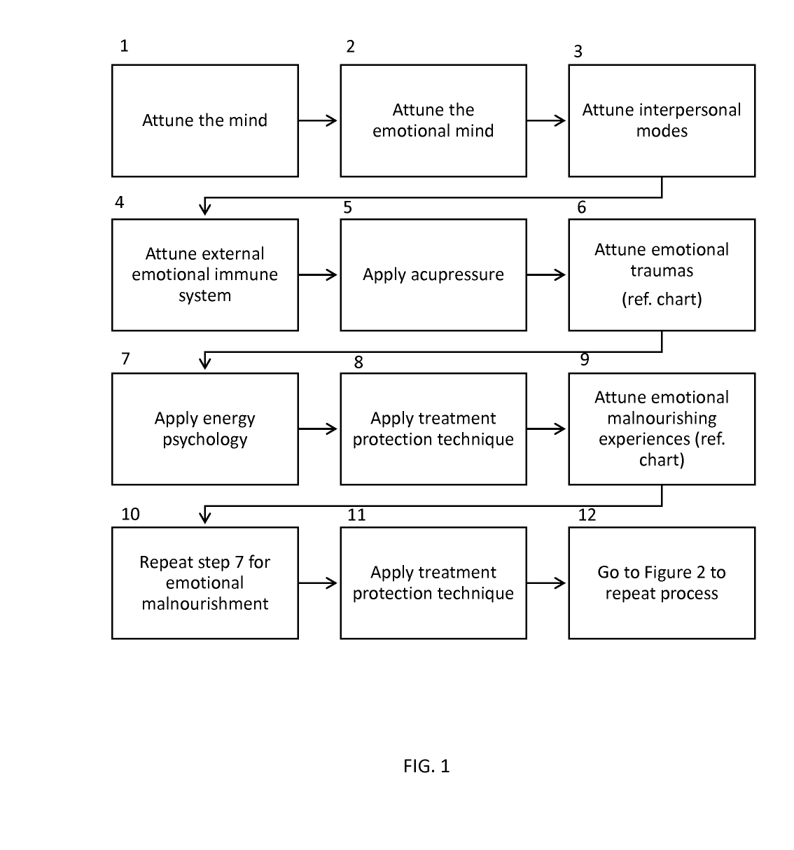

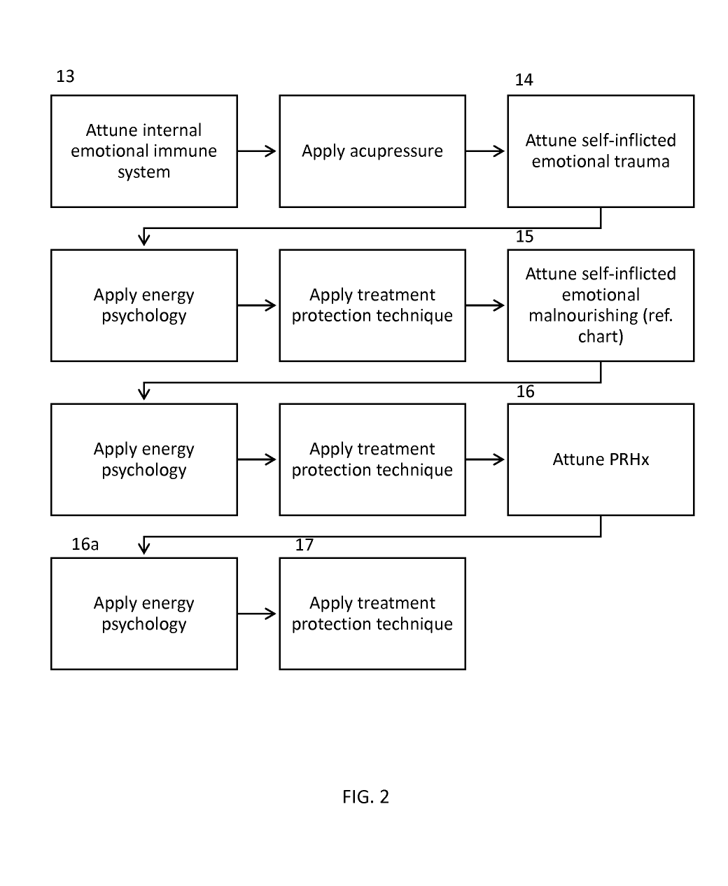

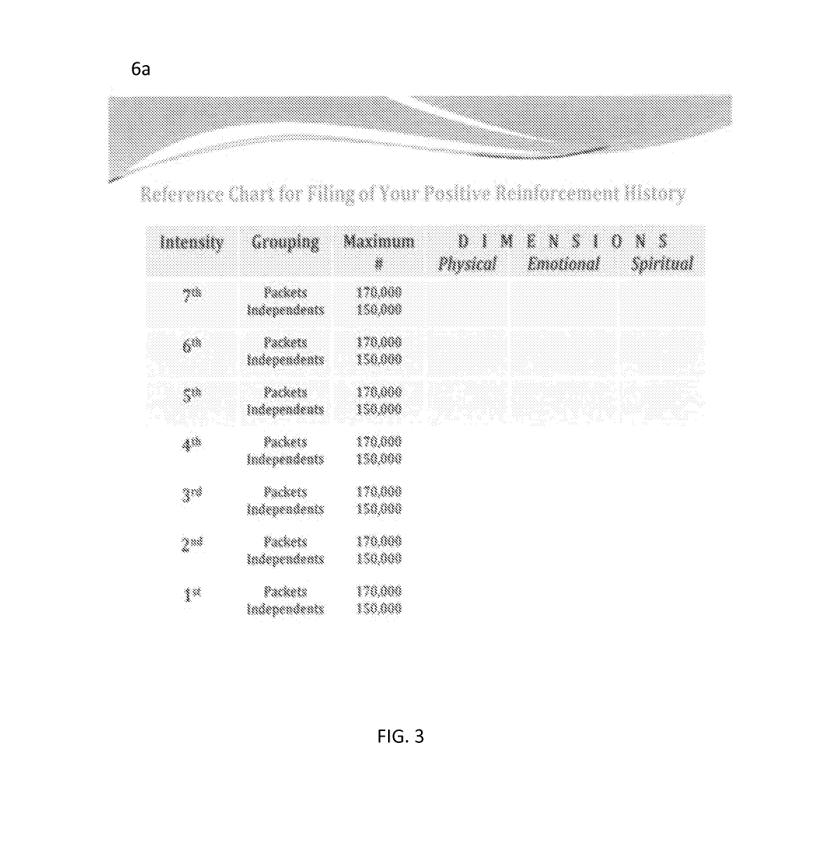

With reference then to FIGS. 1-3, the instant program is a mental health treatment program including the following steps as being done by a treating psychologist on a patient user. First, attune the mind 1. To attune is to move stored information (memories) to a higher level of consciousness than all other stored information, thus the mind is accessed as a field of energy and information. Next, the emotional mind is attuned 2, or accessed as a sub-field of the mind. Next, interpersonal modes are attuned 3. This means the three interpersonal modes of operation; the parent, the child and adult ego states are accessed. There are three possible roles a human can take when interacting with another human, and these are the three interpersonal modes of interaction, namely the parent (the nurturing role), the child (the nurtured role), and the adult (the peer role). Next, the external emotional immune system is attuned 4. The external emotional immune system is our personality from the outside. i.e.: how we relate to others. It is not how we relate to or how we treat ourselves. Next, acupressure is applied 5. Acupressure is applied to the external emotional immune system. Next, emotional traumas are attuned 6. In this step all emotional traumas are accessed according to a program reference chart as shown as 6a in FIG. 2. Emotional trauma is any subjective experience that hurt or emotionally wounded the individual, e.g. rape, verbal abuse, abandonment. Each negative experience is filed according to seven levels of severity, two groupings (packets of related events and individual events); a maximum number for each (17,000, 170,000 15,000, 150,000; and one of three depths, (the physical, emotional and spiritual. Next, at this point, any effective energy psychology application such as Thought Field Therapy (TFT), Emotional Freedom Technique (EFT) or Tapas Acupressure Technique (TAT) may be applied once the program has accessed the targeted history 7. Preferred is to apply a TFT technique called Psychological Reversal for the trauma and then to tap five or more times on the fourteen treatment points identified by TFT. I then apply the TFT nine gamut application followed by tapping a second time on all fourteen treatment points. Lastly I apply the TFT floor-to-ceiling eyeroll. The specific information is identified as emotionally traumatic experiences and emotionally malnourishing experiences and the subjectively positive experiences associated with maladaptive coping strategies. This entire history is then isolated in the preconscious vestibule of the mind as a large file of active information, and then by tapping on treatment points that correspond with the fourteen corridors of the mind, the active information is resolved. Next, the program then protects the treated areas 8. To protect means to prevent the emotional signal from reactivating. The program then attunes or accesses all emotional malnourishing experiences according to reference chart 6a (FIG. 2), 9. Emotional malnourishment is any subjective experience that depleted the emotional strength and well-being of an individual, e.g. inadequate attention, affection, disregard, unforgiveness. Next, step 7 is repeated for emotional malnourishment 10. Next, the program protects treatment areas 11. Next, the process is repeated 12. For the steps of repeating, the treatment is re-applied in the same manner but with respect to the internal emotional immune system 13, self-inflicted emotional trauma 14, self-inflicted emotional malnourishing 15. Thus, the program then repeats the entire process for these. Next, positive reinforcement history (PRHx) is attuned 16. The positive reinforcement history is the subjective memory of the positive signal associated with bad habits, e.g. the high received from drinking alcohol or the relief experienced from procrastination. The PRHx is attuned according to program reference chart 6a (FIG. 3). Any effective energy psychology application is then applied to the PRHx 16a. Finally, treatment protection technique is applied to the PRHx 17.

In summary, steps 1-3 guide the patient to the general area of the mind needing treatment. Step 4 & 5 softens the emotional mind's resistance to change. To “soften” is to facilitate acceptance of the disorder, i.e. with the active alcoholic, sobriety cannot begin before the alcoholic accepts that he is ill. Step 6 isolates traumatic experiences. Steps 7 & 10 resolve active traumatic experiences and emotional malnourishment. “Resolve” means to deactivate active information neutralizing its signal, specifically, its emotional signal. Steps 8 & 11 protect the resolutions of active traumatic and emotionally malnourishing experiences. To “protect” means to prevent the emotional signal from reactivating. Steps 9 & 10 isolate and resolve active emotionally malnourishing experiences. The later steps 12 and on improve the balance of external emotional immune system and repeats all twelve previous steps but the treatment is now focused on the internal emotional immune system, self-inflicted emotional trauma and self-inflicted emotional malnourishing experiences. The last steps treat and protect the treatment of the PRHx.

By following the above-listed steps, many emotional obstacles to emotional well-being can be removed clearing a path to greater success in a wide range of areas. Moreover, unproductive compulsions can be resisted and begin to be replaced with functional behaviors leading to better relationships, careers, and physical health. Most treatments take many months and even years to assist people in accomplishing comparable levels of emotional health. With just one complete application of the program, the same or better results can be realized in just a few hours. Clearing fears and insecurities with this program can enhance performance and therefore improve the outcomes of therapy, coaching, mentoring, supervising and teaching.

I claim:

1. A method for mental health treatment, comprising the steps of:
performing a sequence of operations on a patient, including guiding a patient to an area of the mind needing treatment;
softening said area;
isolating one or more emotional traumas (ET) and emotional malnourishments (EM) of said patient;
resolving said ETs and said EMs, thereby forming resolutions;
protecting said resolutions;
treating and protecting a positive reinforcement history of maladaptive coping behaviors (PRHx), wherein, as a practical application of said operations, maladaptive emotions of said patient are neutralized.

2. The method of claim 1, further comprising the step of improving balance of an external emotional immune system.

3. The method of claim 2, further comprising the step of repeating the steps of claim 1 but as it relates to an internal emotional immune system.

4. The method of claim 1, wherein for the step of guiding said patient, said mind is attuned.

5. The method of claim 1, wherein for the step of guiding said patient, three interpersonal modes are attuned.

6. The method of claim 2, wherein for the step of softening said area, said external emotional immune system is attuned.

7. The method of claim 6, wherein for the step of softening said area, acupressure is applied to said external emotional immune system.

8. The method of claim 1, wherein for the step of isolating said ETs and said EMs, said ETs and said EMs are attuned according to a reference chart.

9. The method of claim 8, wherein any negative experience associated with said ETs or said EMs is filed according to seven levels of severity, two groupings, and one of three depths.

10. The method of claim 9, wherein for the step of treating and protecting said PRHx, said PRHx is attuned according to said reference chart.

11. A computer program product comprising a non-transitory computer-readable medium having control logic stored therein for causing a computer to aid in evaluating and treating musculoskeletal pain, the control logic comprising computer-readable program code for causing the computer to:
perform a sequence of operations on a patient, including guide a patient to an area of the mind needing treatment;
soften said area;
isolate one or more emotional traumas (ET) and emotional malnourishments (EM) of said patient;
resolve said ETs and said EMs, thereby forming resolutions;
protect said resolutions; and,
treat and protect a positive reinforcement history of maladaptive coping behaviors (PRHx), wherein, as a practical application of said operations, maladaptive emotions of said patient are neutralized.

12. The product of claim 1, further comprising the step of improving balance of an external emotional immune system.

13. The product of claim 11, further comprising the step of repeating the steps of claim 11 but as it relates to an internal emotional immune system.

14. The product of claim 11, wherein for the step of guiding said patient, said mind is attuned.

15. The product of claim 11, wherein for the step of guiding said patient, three interpersonal modes are attuned.

16. The product of claim 12, wherein for the step of softening said area, said external emotional immune system is attuned.

17. The product of claim 11, wherein for the step of isolating said ETs and said EMs, said ETs and said EMs are attuned according to a reference chart.

18. The product of claim 17, wherein any negative experience associated with said ETs or said EMs is filed according to seven levels of severity, two groupings, and one of three depths.

19. The product of claim 18, wherein for the step of treating and protecting said PRHx, said PRHx is attuned according to said reference chart.
